(19) United States
(12) Patent Application Publication
(10) Pub. No.: US 2004/0114364 A1
(43) Pub. Date: Jun. 17, 2004

(54) Lighting mounting structure

(76) Inventor: Wen-Tsung Chen, Taipei Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/316,009

(22) Filed: Dec. 11, 2002

(51) Int. Cl. F21S 4/00; F21S 8/06

(52) U.S. Cl. 362/225; 362/291; 362/404

(57) ABSTRACT

A lighting mounting structure for mounting a light source, an electronic ballast and a power line, comprises a panel and a mounting frame. The panel has an undulated cross-section, wherein the light source is mounted on a front surface of the panel. The mounting frame includes a plurality of sub-pieces to fix the panel therein. The panel and the frame form the accommodating space for holding the power line. The panel having the downwardly recessed section and the upwardly recessed section on the opposite surfaces can receive the light source, the electronic ballast and the power line with a reduced size.

### BACKGROUND OF THE INVENTION

1. Field of the Invention

The invention relates to a lighting mounting structure. More particularly, the invention provides a lighting mounting structure that has a reduced size.

2. Description of the Related Art

A ceiling lighting provides good illumination. Referring to FIG. 1, a conventional lighting used in a suspended grid ceiling includes a lamp socket 1. A plurality of openings 2 are delimited in a front portion of the lamp socket 1 by a plurality of partitions 7, the openings 2 downwardly facing an interior space of the room. A light source 3 is mounted in each opening 2. An electronic ballast 4 is externally mounted on a rear surface of the lamp socket 1. The light source 3 is electrically connected to the electronic ballast 4 via a power line 5 that is collected on the rear surface of the lamp socket 1. A lid 6 covers the electronic ballast 4 and the power line 5. The ceiling lighting is mounted in the suspended ceiling.

In the above conventional lighting, the electronic ballast 4 and the power line 5 located on the rear surface of the lamp socket increase the thickness of the lighting mounting structure. An extra space for the electronic ballast 4 and the power line 5 accordingly has to be left between the suspended ceiling and the concrete ceiling, additional to a space for accommodating the piping and wiring of the building. These spaces negatively reduce the height of the room space. Furthermore, the above lighting mounting structure, with the electronic ballast and the power line being externally exposed, is not suitable for being suspended below the ceiling.

### SUMMARY OF THE INVENTION

It is an object of the invention to provide a lighting mounting structure which allows a size reduction of the lighting structure.

It is another object of the invention to provide a lighting mounting structure that can conceal the electronic ballast and the power line to embellish the profile of the lighting mounting structure.

Furthermore, it is another object of the invention to provide a lighting mounting structure that can be implemented in various configurations.

In order to achieve the above and other objectives, a lighting mounting structure of the invention is used to mount a light source, an electronic ballast and a power line. The mounting structure comprises a panel and a mounting frame. The panel has an undulated cross-section, and the light source is mounted on a front surface of the panel. The mounting frame includes a plurality of sub-pieces to fixedly fasten the panel therein. The panel and the frame form the accommodating space for holding the power line.

To provide a further understanding of the invention, the following detailed description illustrates embodiments and examples of the invention, this detailed description being provided only for illustration of the invention.

### BRIEF DESCRIPTION OF THE DRAWINGS

The drawings included herein provide a further understanding of the invention. A brief introduction of the drawings is as follows:

FIG. 1 is a cross-sectional view of a conventional lighting mounting structure;

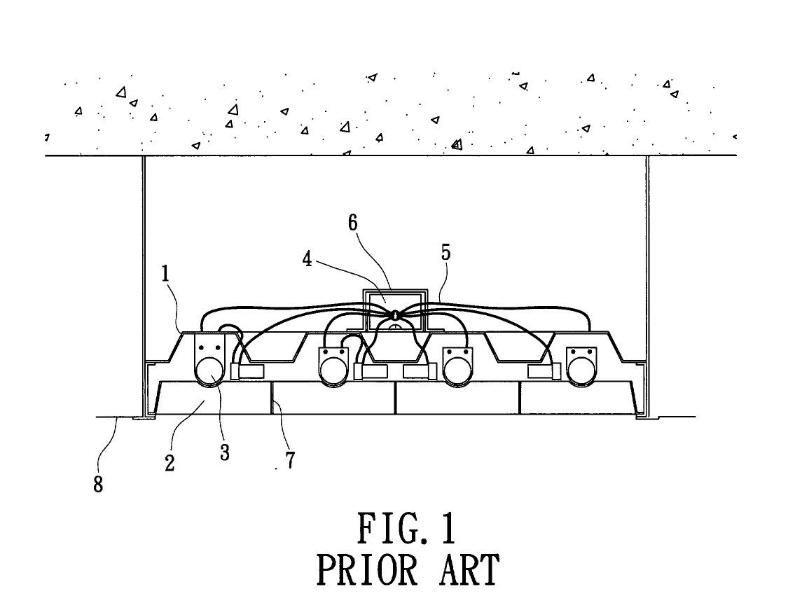

FIG. 2 is a perspective view of a lighting mounting structure according to an embodiment of the invention;

FIG. 3 is a perspective view of a lighting mounting structure according to an embodiment of the invention taken from another angle of view;

FIG. 4 is an exploded view of a panel and a supporting member of a lighting mounting structure according to an embodiment of the invention;

FIG. 5 is an exploded view of a panel and a supporting member taken from an angle of view of the lighting source within the lighting mounting structure according to an embodiment of the invention;

FIG. 6 is an exploded view of a panel and a supporting member taken from a angle of view of the electronic ballast within the lighting mounting structure according to an embodiment of the invention;

FIG. 7 is an exploded view of a panel and a supporting member taken from an angle of view of the lighting source within the lighting mounting structure according to an embodiment of the invention;

FIG. 8 is an exploded view of a panel and a supporting member taken from an angle of view of the lighting source within a lighting mounting structure according to another embodiment of the invention;

FIG. 9 is a cross-sectional view showing a power line that is collected within a lighting mounting structure according to an embodiment of the invention;

FIG. 10 is a top view of a partition before being punched according to an embodiment of the invention;

FIG. 11A is a perspective view of a partition after having being punched according to an embodiment of the invention; and

FIG. 12 is cross-sectional view of a lighting mounting structure that has partitions and is suspended below a ceiling according to another variant embodiment of the invention.

### DETAILED DESCRIPTION OF THE EMBODIMENTS

Wherever possible in the following description, like reference numerals will refer to like elements and parts unless otherwise illustrated.

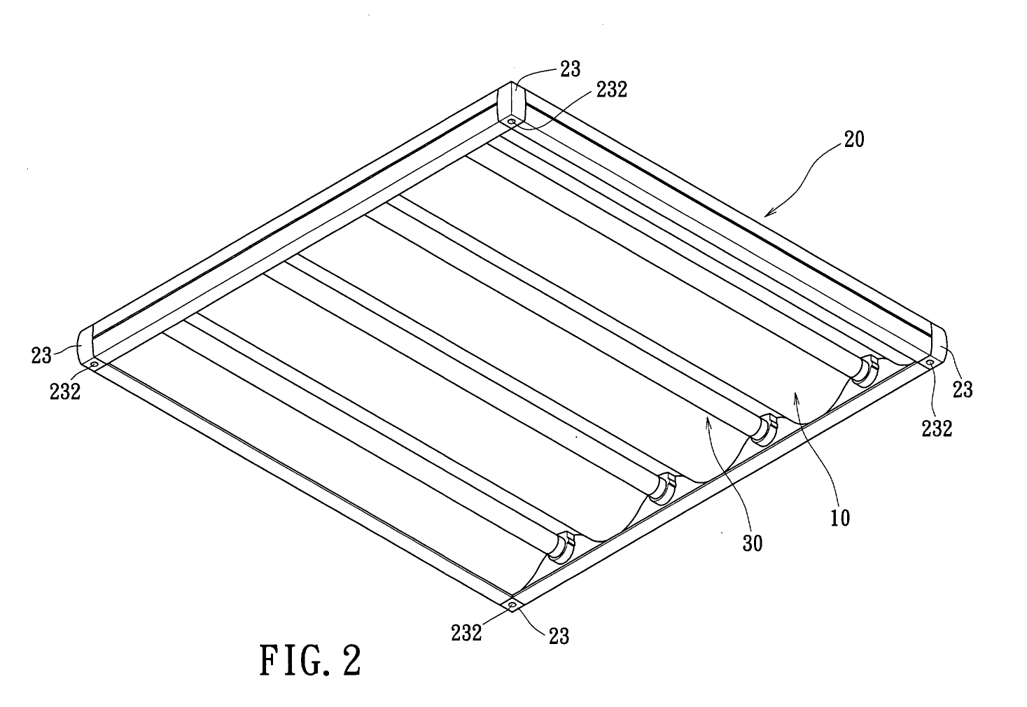

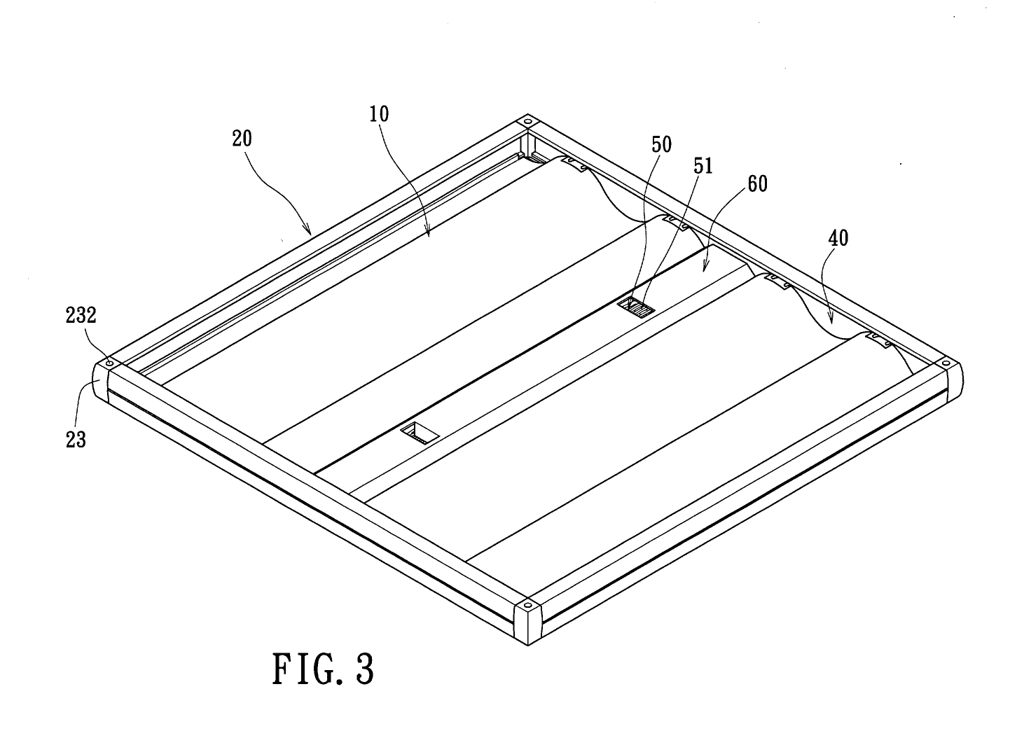

Referring to FIG. 2 and FIG. 3, a lighting mounting structure, for respectively mounting a light source 30, an electronic ballast 50 and a power line 51, includes a panel 10, and a mounting frame 20.

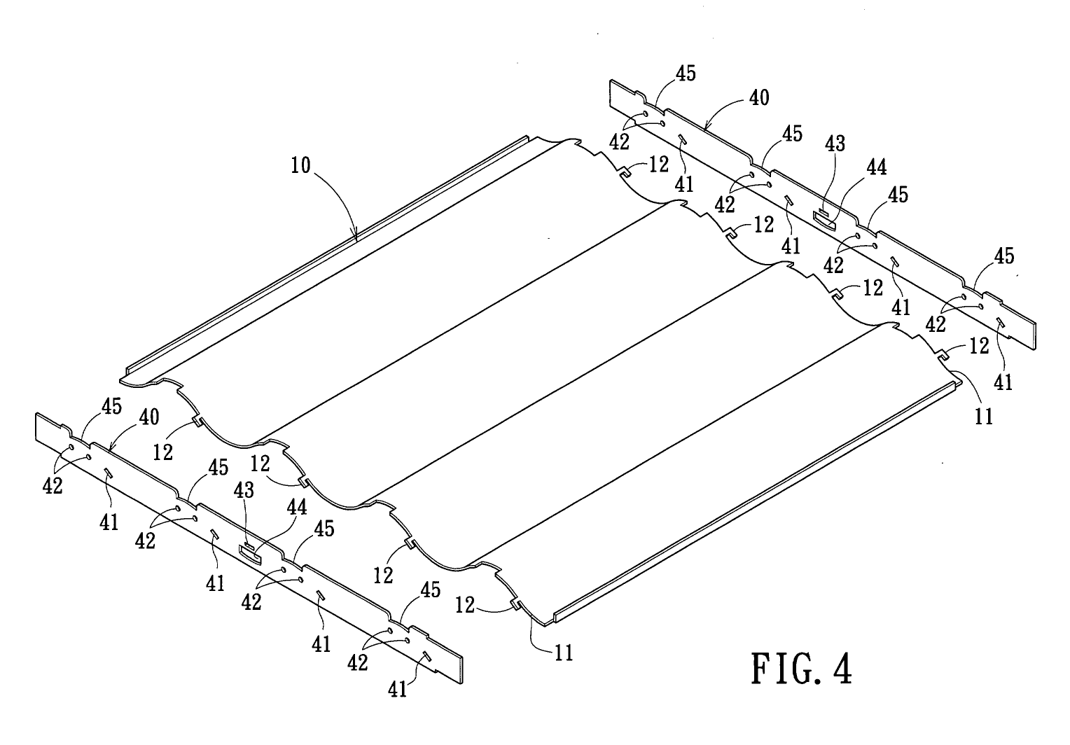

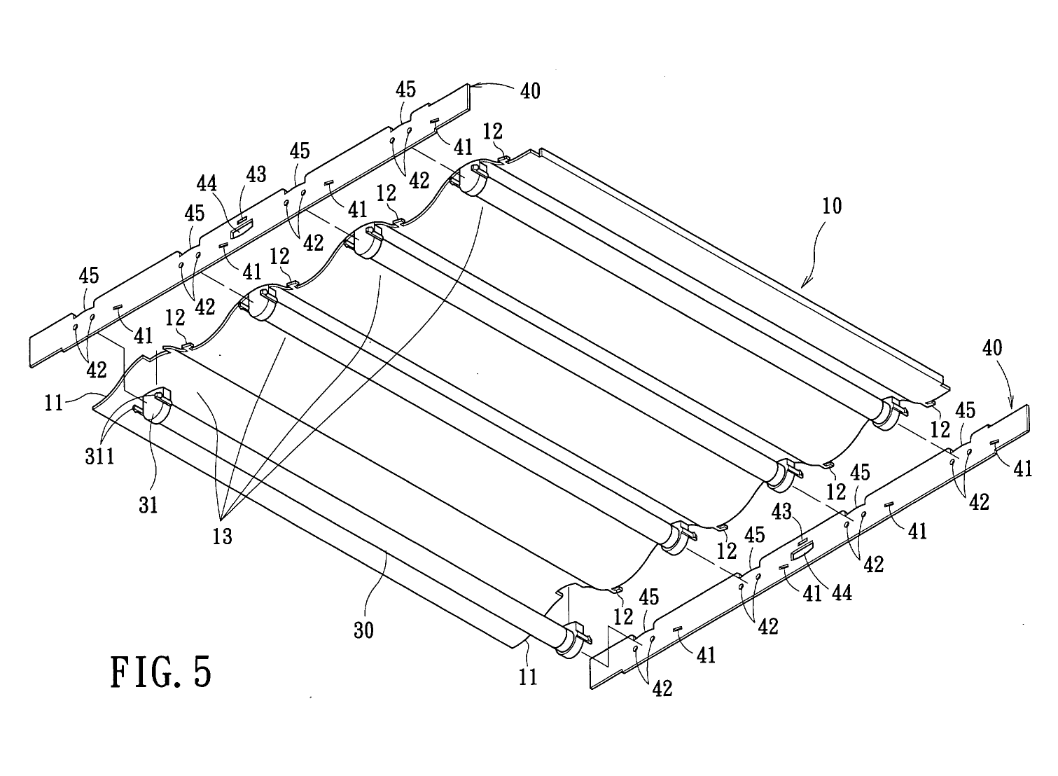

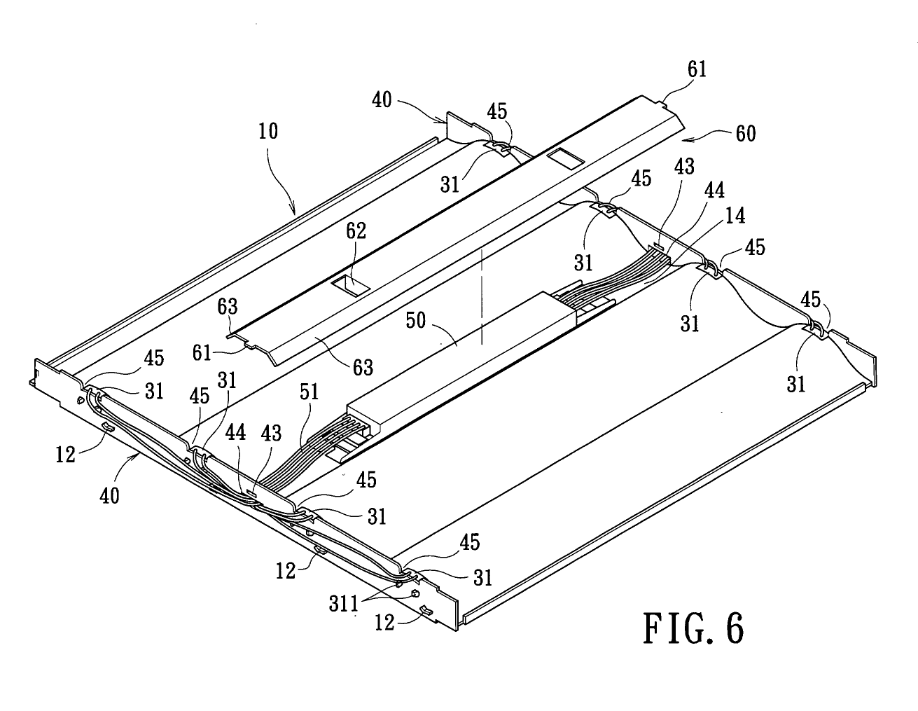

Referring to FIG. 4 and FIG. 5, the panel 10 is made of, for example, aluminum, and has an undulated cross-section that may be either formed in a single body or by assembling separate arcuate sub-pieces. The panel 10 has two opposite undulated cross-sectional rims 11. These two opposite sides of the panel 10 are respectively mounted with supporting members 40 that are perpendicular to the undulated cross-sectional rims 11. The supporting members 40 are made of, for example, aluminum. The panel 10 engages with the supporting members 40 by an engagement structure that includes a plurality of L-shaped projections 12 on each cross-sectional rim 11. Each supporting member 40 has a plurality of engaging holes 41 respectively corresponding to the projections 12. As shown in FIG. 6, a tail of each L-shaped projection 12 is bent after having being inserted through the corresponding engaging hole 41 to prevent its undesirable disengaging from the engaging hole 41. A front side of the panel 10 has at least one downwardly recessed section 13 for receiving the light source 30. Each supporting member 40 further has a plurality of pin holes 42 for receiving pins 311 provided at two opposite ends 31 of the light source 30 to position the light source 30.

Referring to FIG. 6, a rear surface of the panel 10 has at least one upwardly recessed section 14 adjacent to the downwardly recessed section 13. The electronic ballast 50 is mounted on the upwardly recessed section 14 and is electrically connected respectively to the ends 31 of the light source 30 and an external power supply by means of the power line 51. Each supporting member 40 further has at least one line hole 44 and at least one slot 45 through which the power line 51 inserts. The power line 5 is collected at a proper location on the rear surface of the panel 10. A lid 60 is further provided to cover the electronic ballast 50. The lid 60 has, for example, a stripped shape. The lid 60 includes abutments 62, 63 that together are dedicated to the mount of the lid 60 for encapsulating the electronic ballast 50 and the power line 51. Protrusions 61 are formed at two opposite ends of the lid 60 respectively facing the supporting members 40 to respectively engage with corresponding fixing holes 43 on the supporting members 40 in order to secure the electronic ballast 50 on the upwardly recessed section 14 in position. Since the electronic ballast 50 is located on the upwardly recessed section 14, the thickness of the lighting mounting structure is not increased by the electronic ballast 50.

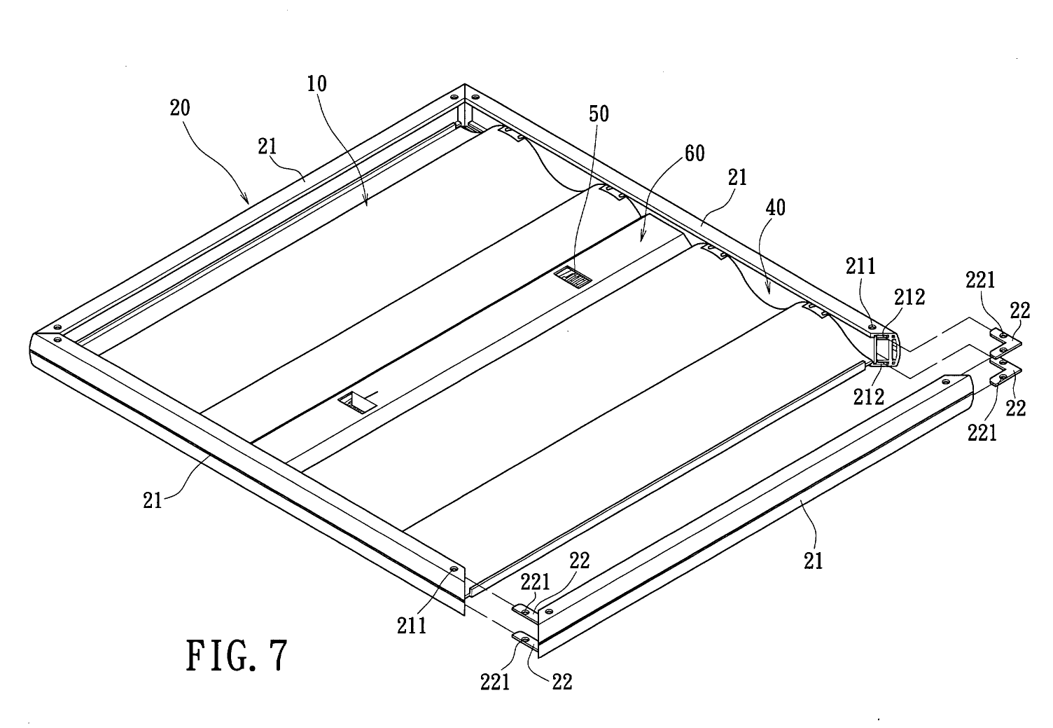

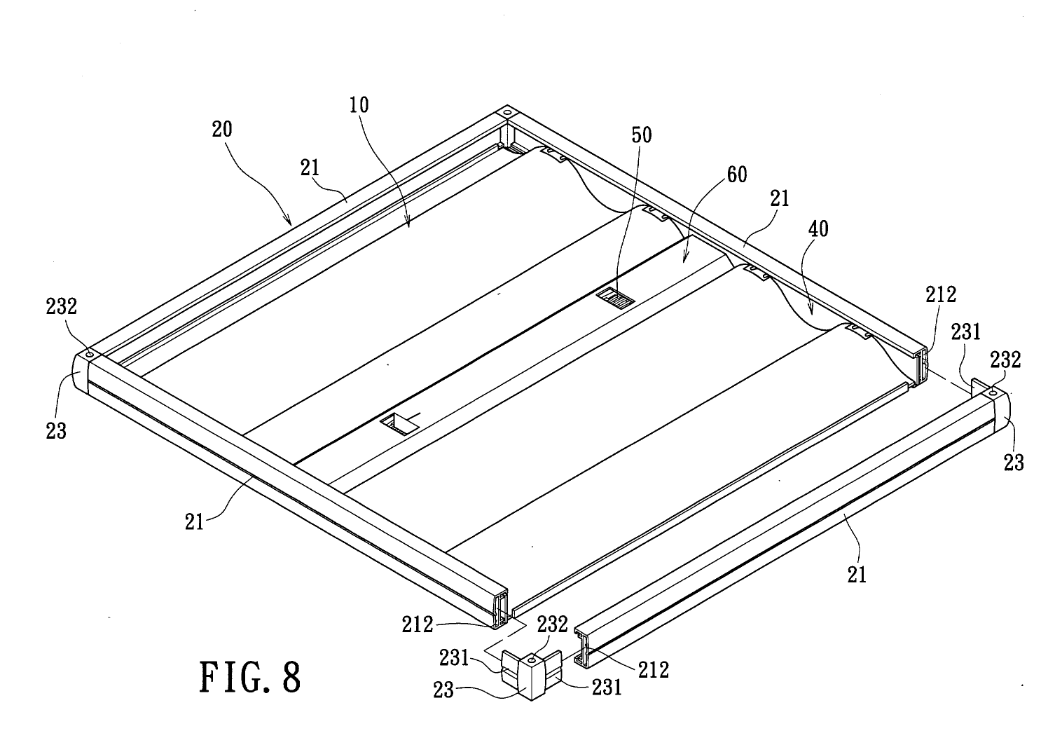

Referring to FIG. 7 and FIG. 8, the mounting frame 20 is made of, for example, aluminum. The mounting frame 20 includes four stripped sub-pieces 21. A slot 212 is formed at each end of each sub-piece 21. The sub-pieces 21 are connected to one another by respectively inserting in the slots 212 a connection member such as a L-shaped pin 22 or a bar 23 having a flange 231. The sub-pieces 21 and the pins 22 respectively have threaded holes 211, 221 corresponding to each other for receiving a nut. Each bar 23 respectively has a threaded hole 232.

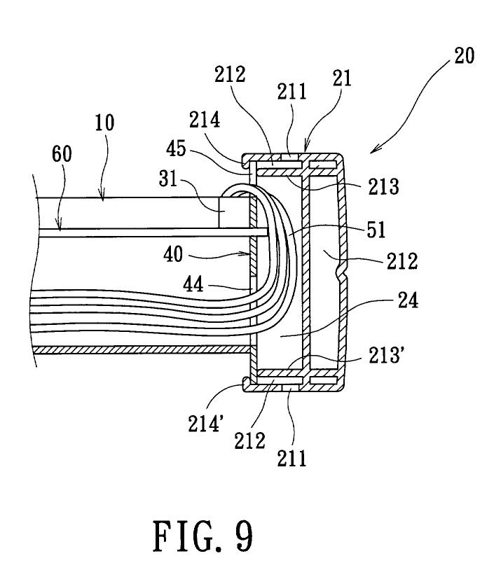

Referring to FIG. 9, flanges 214, 214′ corresponding to each other are formed on opposite side of each sub-piece 21, facing the supporting member 40. Pressing members 213, 213′ are further formed inside each sub-piece 21 to press against the supporting members 40 when the supporting members 40 are pushed into each sub-piece 21 through the flanges 214, 214′, thereby the panel 10 is fixedly attached in the frame 20. Meanwhile, the supporting members 40 and the mounting frame 20 form an accommodating space 24 for holding the power line 51.

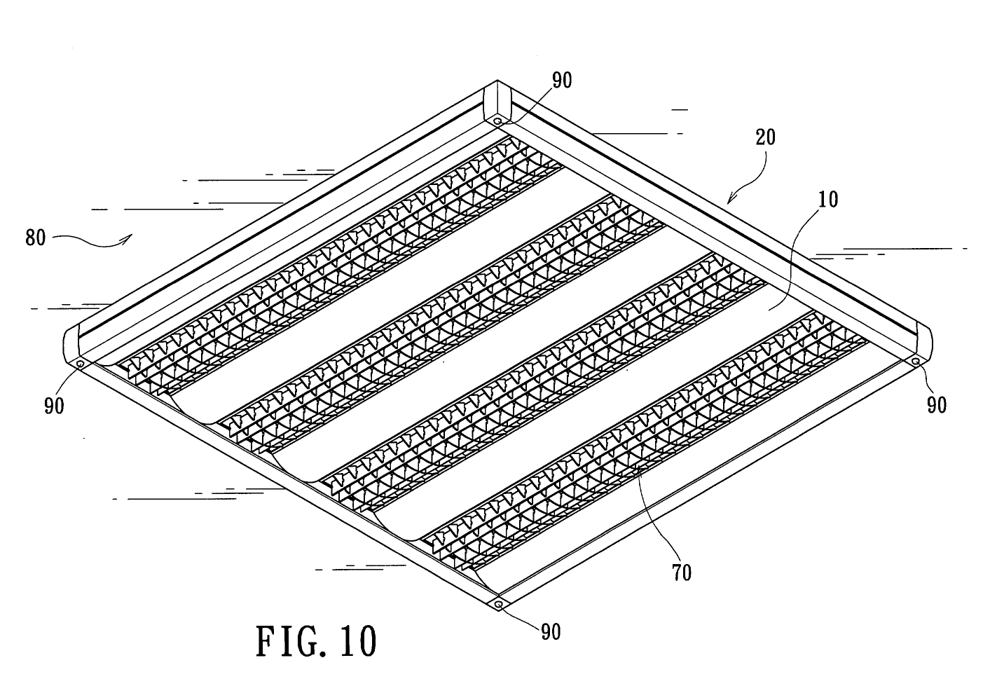

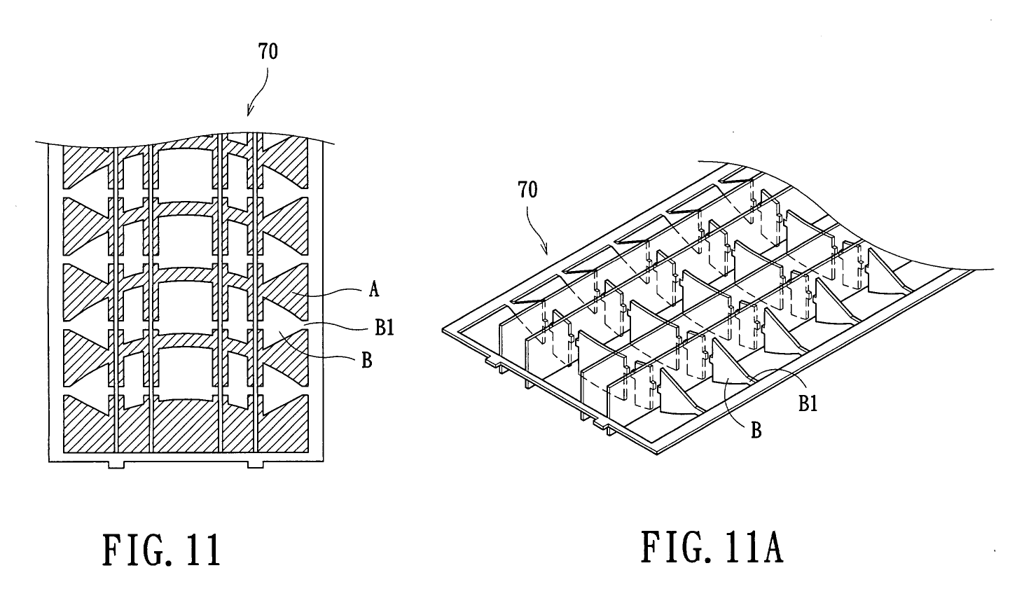

Referring to FIG. 10, the panel 10 can be further provided with a plurality of partitions 70 to embellish the light source 30. The partitions 70 are arranged according to the locations of the downwardly recessed sections 13. As shown in FIG. 11, each of the partitions 70 is formed by, for example, punching. For example, an aluminum workpiece is punched to remove hatched sections A, which leaves remaining blank sections B. The blank sections B are respectively rotated an angle of 90 degrees using the corresponding portions B1 as rotation points.

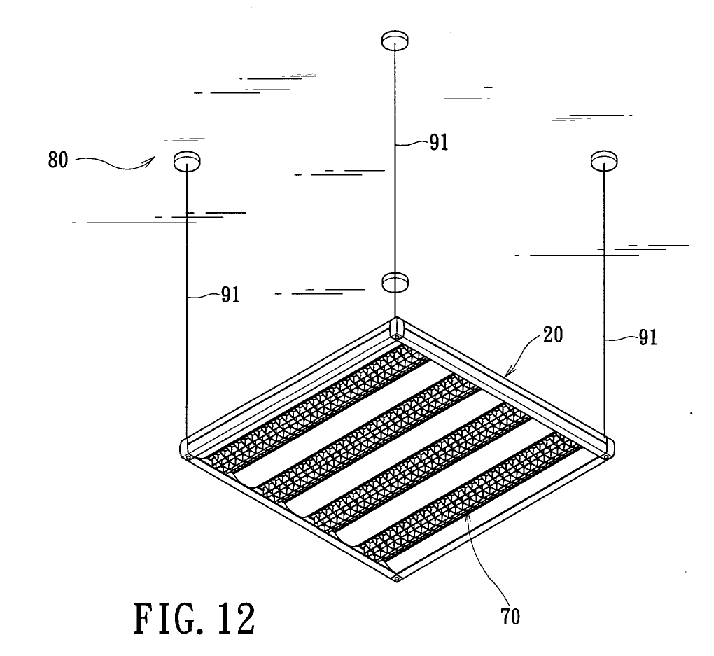

With the configuration of the invention, the size of the lighting assembly is therefore favorably reduced while being embellished. The lighting mounting structure of the invention can be mounted to, for example, the ceiling 80. As shown in FIG. 10, the lighting mounting structure can be screwed onto the ceiling 80 by inserting a nut 90 through the mounting frame 20. As shown in FIG. 12, the lighting mounting structure of the invention can be suspended below the ceiling 80 by a hanger 91.

As described above, the invention therefore includes the following advantages.

1. The panel, having the downwardly recessed section and the upwardly recessed section on opposite surfaces, can receive the light source and the electronic ballast respectively on the opposite surfaces. Furthermore, the partitions are arranged according to the locations of the downwardly recessed section. Therefore, the size of the lighting mounting structure is favorably reduced.

2. The electronic ballast and the power line are placed on the upwardly recessed section on the rear surface of the panel and are covered by the lid. Therefore, the lighting mounting structure of the invention has a more aesthetic profile.

3. The lighting mounting structure of the invention can be inserted inside the surface of the ceiling, mounted on the surface of the ceiling, or suspended below the ceiling.

It should be apparent to those skilled in the art that the above description is only illustrative of specific embodiments and examples of the invention. The invention should therefore cover various modifications and variations made to the herein-described structure and operations of the invention, provided they fall within the scope of the invention as defined in the following appended claims.

What is claimed is:

1. A lighting mounting structure for mounting a light source, an electronic ballast and a power line, the lighting mounting structure comprising:
a panel, having an undulated cross-section, wherein the light source is mounted on a front surface of the panel; and
a mounting frame, including a plurality of sub-pieces to fix the panel in the mounting frame, wherein the panel and the mounting frame form an accommodating space for holding the power line.

2. The structure of claim 1, wherein the electronic ballast is mounted on an upwardly recessed section of a rear surface of the panel.

3. The structure of claim 2, wherein two opposite sides of the panel are respectively mounted with supporting members that are perpendicular to undulated cross-sectional rims of the panel, the panel being respectively engaged with the supporting members by an engagement structure.

4. The structure of claim 3, wherein the engagement structure includes a plurality of L-shaped projections formed on the undulated cross-sectional rims, and each supporting member has a plurality of engaging holes respectively corresponding to the L-shaped projections, a tail of each L-shaped projection being bent after having been inserted into the corresponding engaging hole to prevent its undesirable disengaging from the engaging hole.

5. The structure of claim 4, wherein the electronic ballast is mounted on the upwardly recessed section and is electrically connected to the ends of the light source and an external power supply by means of the power line.

6. The structure of claim 4, wherein a lid is further provided to cover the electronic ballast, two ends of the lid respectively facing the supporting members respectively form protrusions that engage with corresponding fixing holes on the supporting members in order to secure the electronic ballast on the upwardly recessed section.

7. The structure of claim 1, wherein at two ends of each sub-piece is respectively formed a slot, through which each sub-piece is connected to one another by respectively inserting a L-shaped pin.

8. The structure of claim 1, wherein at two ends of each sub-piece is respectively formed a slot, through which each sub-piece is connected to one another by inserting a bar having a flange.

9. The structure of claim 3, wherein flanges are formed on opposite sides of each sub-piece at locations oppositely facing one supporting member, and pressing members are formed inside each sub-piece to press against the supporting member when the supporting member is pushed into the sub-piece through the flanges to fixedly fasten the panel in the frame, the supporting member and the mounting frame forming the accommodating space.

10. The structure of claim 1, wherein a plurality of partitions are further mounted on the front surface of the panel to embellish the light source.

11. The structure of claim 1, wherein the lighting mounting structure is screwed on the ceiling by using a nut.

12. The structure of claim 1, wherein the lighting mounting structure is suspended below the ceiling by a hanger.
